(19) United States
(12) Patent Application Publication
(10) Pub. No.: US 2002/0153424 A1
(43) Pub. Date: Oct. 24, 2002

(54) Method and apparatus of secure credit card transaction

(76) Inventor: Chuan Li, Fremont, CA (US)

Correspondence Address: Otto O. Lee, Esq., Intellectual Property Law Group, Suite 1212, 12 South First Street, San Jose, CA, 95113, US

(21) Appl. No.: 09/838,954

(22) Filed: Apr. 19, 2001

(51) Int. Cl. G06K 19/06

(52) U.S. Cl. 235/492

(57) ABSTRACT

This invention relates to the method and apparatus for conducting secure credit card transaction and providing personal identification on the Internet. It is specifically characterized by a plastic body in regular credit card dimension implanted with a complete microcomputer system and an associated authentication server, implementing dynamic digital certificate authentication technology in order to prevent personal privacy from being breached in e-commerce transactions.

### CROSS-REFERENCES

This application is derived and claims priority from two of the applicant's earlier invention disclosures, which are hereby incorporated by reference for all purposes. The first was filed with the United States Patent and Trademark Office on Dec. 8, 1999, entitled, “Smart Security Credit Card System” with a U.S. Pat. No. 466,207. The second was filed on Feb. 8, 2000, entitled “System, Method, and Apparatus of Dynamic Digital Certificate Authentication for Credit Card Transaction” with a U.S. Pat. No. 468,831.

### BACKGROUND

This invention relates to secure credit card transactions and providing personal identification on the Internet. It is specifically characterized by a plastic body in regular credit card dimension implanted with a complete microcomputer system (hereafter called SecuAll Card) and an associated authentication server, implementing dynamic digital certificate authentication technology in order to prevent personal privacy from being breached in e-commerce transactions.

Credit card fraud has been a problem around the world from the inception of the credit card transaction system nearly half a century ago. Each year credit card related fraud and theft causes billions of dollars of loss to the merchants, credit card issuing companies, and cardholders. The primary problem with a transaction using a conventional credit card is the relative ease in which an unauthorized transaction can be processed. This fraud is facilitated by the direct access to the account information, which is shown on the front of the credit card and the cardholder signature, which is written on the back. Once an unauthorized user gains access to a cardholder's account information and signature, either by gaining physical possession of the card or by any other means, the unauthorized user can simply forge the cardholder's signature as shown on the back of the card to authorize any purchase. A cardholder who has lost her credit card may subsequently cancel the credit card, to prevent further unauthorized use. However, typically by the time the cardholder realizes her loss, a great damage has already been done, not all of which may be undone by the credit company or the merchants involved. The credit cardholder may then be forced to bear the cost of the unauthorized purchases.

In addition to personal financial liability that may be incurred due to loss of a conventional credit card, the holder also suffers from compromised security regarding his or her personal credit and account information such as the account number, expiration date, the cardholder's name, and the cardholder's signature, which may also be misused to conduct unauthorized transactions. A dishonest or tempted merchant, who gains access to a cardholder's personal credit and account information, may easily decide to use such information to conduct an unauthorized transaction without the actual credit card physically leaving the possession of the cardholder. This leads to a greater chance that the unauthorized credit card transaction will not be prevented.

With emerging technologies for e-commerce (like mobile banking, online stock transaction, online bill payment, etc.,) personal account access using a static password is easily breached, resulting in the violation of the personal privacy.

Therefore it is desirable to have new, alternative and effective instruments to authenticate credit card transaction requests, to protect online personal privacy, and to minimize the chance of fraud in credit card transactions.

### SUMMARY

The present invention provides an effective instrument to authenticate credit cared transactions, and to protect personal privacy online, thereby reducing the opportunity for credit card fraud. This invention is a novel apparatus-SecuAll card implementing a dynamic digital certification and a symmetric encryption authentication system for securing authorized financial transaction using a credit card and for personal online account access.

In the preferred embodiment, the smart security system comprises a secure transaction electronic card (SecuAll card). The card mainly consists of a conventional plastic body in the dimension of a conventional credit card, a magnetic strip simulator, a micro controller unit, a membrane keypad, a coin cell battery, two micro switches, an ultra-thin liquid crystal display (LCD) panel, and other electronic components. The simulator emulates a magnetic flux, as does a regular magnetic strip when the card passes through a conventional credit card read device. In order to prevent the electronic card from unauthorized activation, the electronic card employs a personal identification number (PIN) in the form of a combination of digits for the low-end model of the electronic card, or uses fingerprint recognition for the high-end model of the electronic card. The card, usually in standby mode, is to be activated only after the micro controller unit verifies the PIN input from the membrane keypad (typically having 10 digits) or the captured fingerprint. If an incorrect PIN or fingerprint is detected, the micro controller unit will not generate the magnetic flux on the magnetic strip simulator and return immediately to the standby mode. Therefore, none of the transaction data nor the digital certificate would be transmitted to the card read device, and nothing would be displayed on the liquid crystal display panel.

In an alternative embodiment, the traditional transaction data (account number, cardholder's name, and expiration date) would not be private, however, the financial transaction would fail or access to a personal account would be denied without the electronic card being physically presented. Despite the potential availability of the transaction data, the request could not pass the authentication stage without the correct instant digital certificate, because the identity verification of the electronic card user is based on the authentication of the digital certificate, rather than conventional card data, such as a signature. Additionally, each certificate is valid only once. The dynamic digital certificate, in form of a combination of 6 or more digits, is uniquely issued for each transaction, and then expires. The digital certificate is authenticated for each unique transaction, and therefore provides no value to any individual who subsequently attempts to use the date to effectuate further transactions outside the presence of the cardholder. The certificate, generated by an algorithm within the card, is a function of variables which include: the 16-digit credit card account number, the card issuing date (year, month, and date in Greenwich Mean Time (GMT) and time (hours and minutes in GMT), and the instant date and time at which a transaction is being processed. Upon receiving a transaction request, a transaction authentication server would then calculate a unique confirmation code by executing the same algorithm with the received traditional data (account number, cardholder's name, and expiration date), the pre-stored card issuing date and time, and the instant transaction time in GMT. The authentication server would approve the transaction request upon verifying the identity between the certificate and the confirmation code.

For personal privacy protection in online transactions, the digital certificate displayed on the electronic card's liquid crystal displaypanel would replace the current use of static passwords. The digital certificate would first need to be entered from a computer or Personal Digital Assistant keyboard or the keypad on a mobile or a regular phone. It would then be transmitted to the transaction processor for verification through the network, in the same manner as the financial transaction process described above.

Another benefit to SecuAll electronic card cardholders is that one electronic card can be used as multiple plastic credit cards. In other words, it is able to function as a VISA, MasterCard, Discover, or American Express card, depending on the cardholder's selection before use. Furthermore, the authentication system enables SecuAll electronic card cardholders to have their privacy protected regardless of whether a transaction is carried out through e-commerce, wireless or wired telephone, mail order, or brick & mortar retail without any change in the basic infrastructure or the third party involved.

The present invention satisfies the long felt need of having an effective and secure credit card transaction method by implementing SecuAll electronic card and associated symmetric encryption authentication technology into the credit card transaction system. In addition, the invented system is able to provide the protection of personal privacy online. Therefore, the invention will greatly promote consumers (SecuAll cardholders) to freely embrace e-commerce and emerging technologies.

### DETAILED DESCRIPTION OF THE DRAWINGS

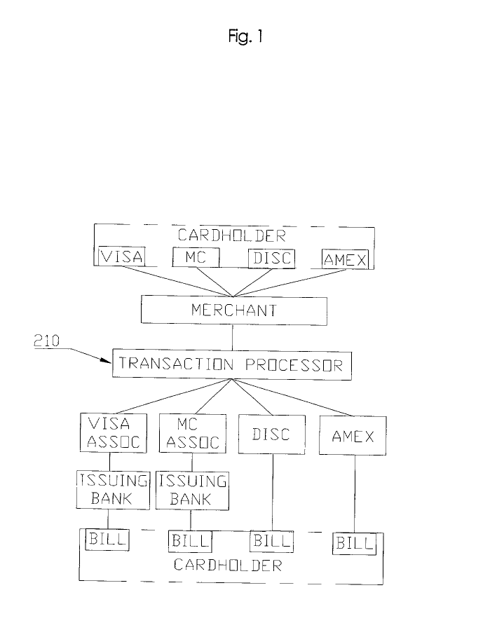

FIG. 1 depicts a typical credit card transaction process.

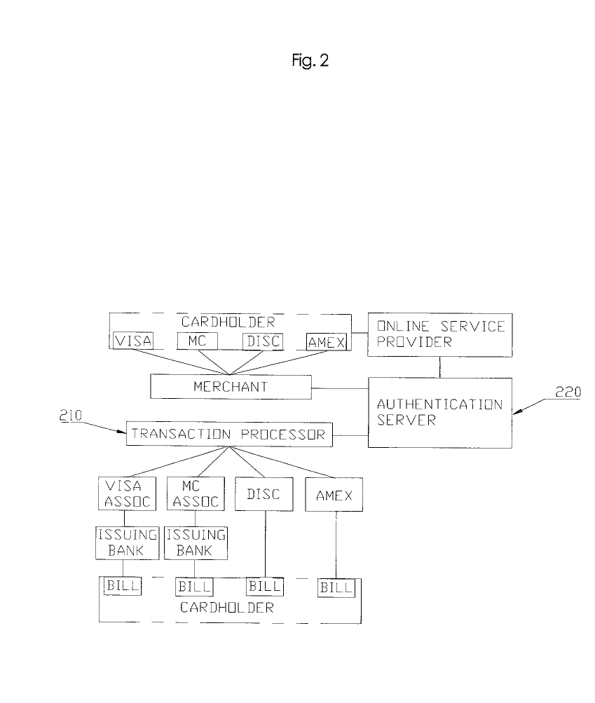

FIG. 2 demonstrates the authentication process.

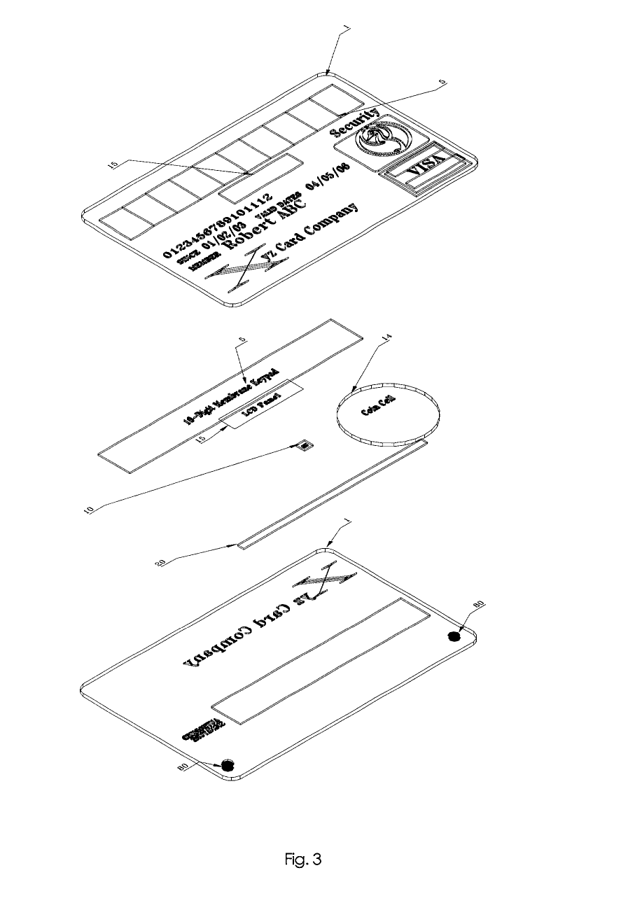

FIG. 3 is an isometric view of the SecuAll electronic card of the present invention.

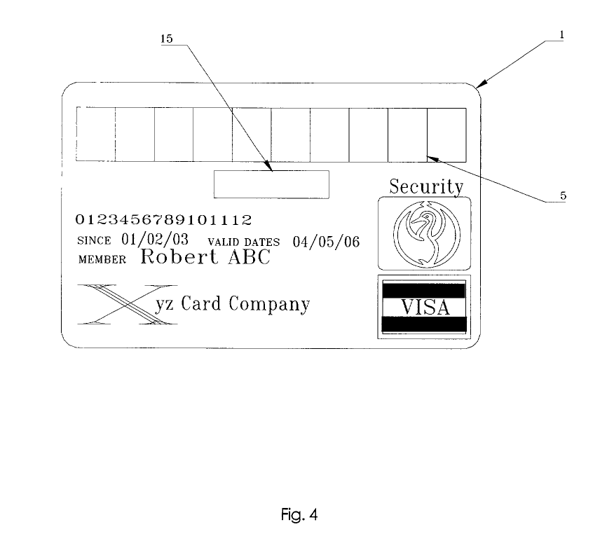

FIG. 4 shows the top surface of the electronic card of the present invention.

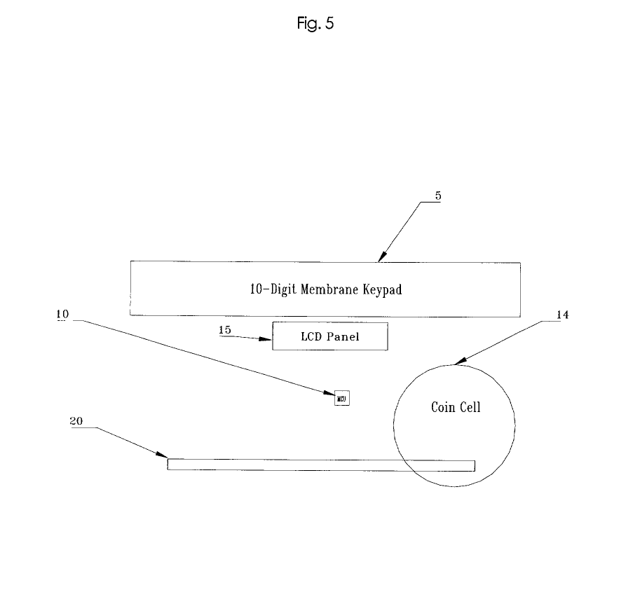

FIG. 5 illustrates main electronic parts and components situated inside the electronic card of the present invention.

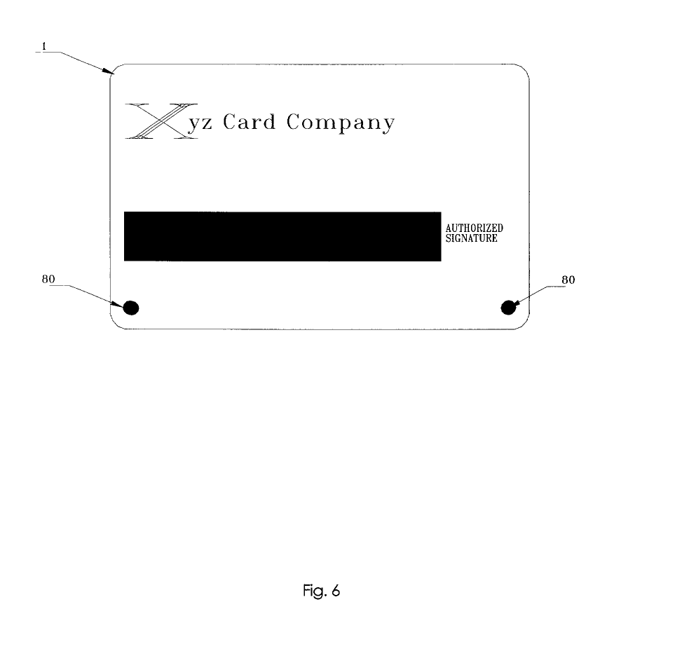

FIG. 6 is a bottom view of the electronic card of this invention.

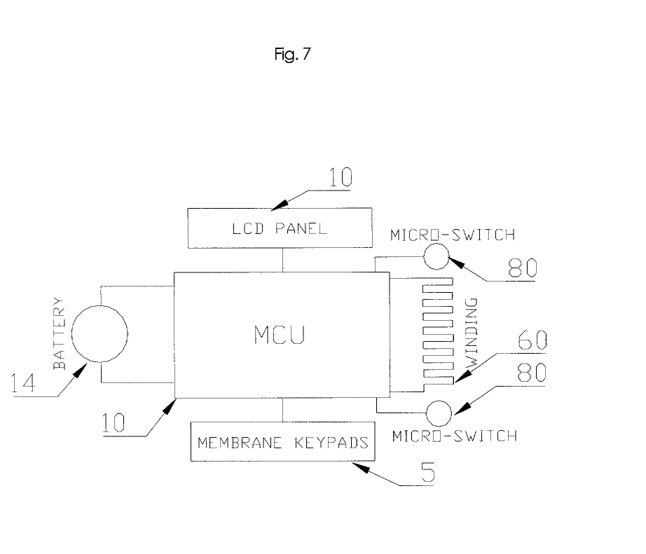

FIG. 7 portrays logic linking of electronic components inside the electronic card of the present invention.

### DETAILED DESCRIPTION OF THE INVENTION

One goal of the present invention is to provide an authentication system based on an electronic card 1 and an authentication server 220 with a dynamic digital certificate verification to prevent the breaching of personal privacy on either credit card transactions or in online personal identification. This solution results in one card to secure all personal privacy in e-commerce. With today's advanced technology, an entire microcomputer system as disclosed in the present invention can be implanted in a conventional plastic credit card without requiring the alteration of its dimensions or modification of current credit card transaction instruments. In lieu of a handwritten signature, a user of a credit card implementing the smart security system must key in a pre-assigned personal identification number (PIN) through a multiple digit membrane keypad 5 mounted on the card surface, which is verified by a micro controller unit 10 embedded inside the electronic card 1. A character value of a particular cardholder's fingerprint can also be pre-stored in the high-end version of the electronic card 1 as an alternative to the PIN. The micro controller unit 10 captures the fingerprint through an integrated fingerprint sensor, implements an Analog-to-Digital (A/D) conversion, and then calculates out a character value which it compares to the pre-stored one for confirmation. Only after the verification of the PIN or the fingerprint can the electronic card 1 be activated to transmit the transaction data of the particular electronic card 1 to the authentication server 220 through a card read device or other instrument. At the server 220, a financial transaction or an online service request is instantly cleared only if a confirmation code from the symmetric encryption algorithm is identical to the dynamic digital certificate code received from the card. Unlike the smart card, the electronic card 1 is 100% compatible with any kind of transaction instrument, including those commonly used worldwide and emerging financial transaction technologies like cellular or regular telephones, PDAs, or 2-way pagers. For the personal identification for the online service request, no special read device or software driver is required. Because the request is approved in terms of the certificate confirmation instead of traditional credit card data or personal data, online merchants do not need to worry about the security of personal financial data, which is stored on their databases, against crackers or hackers who wish to steal that information. The replacement of the traditional handwritten signature with the digital certificate will significantly expedite the present checkout process for credit card purchases.

FIG. 1 depicts generally a typical system used to process and settle data card transactions. A merchant collects the transaction data such as the account number, the name of the cardholder, and the expiration date and then transfers them to a transaction processor 210 for transaction clearing and settlement through a network or in the form of paper sales drafts. The data are typically transferred from the transaction processor 210 to the credit card issuer electronically. Once the card issuer receives the data, the transactions are immediately posted or stored for subsequent posting to the appropriate cardholder's account. Settlement occurs as funds are transferred from the issuing institution to the merchant.

The known transaction processing system provides for authorization of transactions and has served the business community well, but the system does not include adequate authentication instruments to prevent fraud. As a matter of fact, as long as a person acquires the transaction data by whatever means, he is readily able to break into this transaction processing system. This is the greatest shortcoming in electronic commerce. The preferred electronic card 1, utilizing the authentication server 220, and implementing symmetric encryption technology, provides a perfect solution to this problem. Without additional cost or devices, the traditional authentication infrastructure offers additional benefit to electronic card 1 cardholders: the privacy protection for personal identification in Business to Consumer (B2C) e-commerce.

The authentication server 220 is to be located between the merchant and the transaction processor 210 as shown in FIG. 2. Once a transaction request is received by the processor 210, it passes corresponding transaction data to the authentication server 220 located between the merchants and the transaction processors 210 for identification. If the verification is authenticated, the server transmits traditional transaction data to the transaction processor 210. The authentication server 220 works like a filter, which screens out all unauthorized transactions or server requests to protect the customers' privacy. Otherwise, the request is blocked and brief information regarding the reason why it was denied provided to the merchant. For the online service request, when an online service provider issues an authentication request to the authentication server 220, it transmits an instant dynamic certificate (so-called “dynamic password”) input by the electronic card 1 cardholder from the keyboard on a personal computer (PC) or other devices and relates the personal data to the authentication server 220. Upon receiving all data, the authentication server 220 performs the same functions as with the credit card transaction request verification: it checks the digital certificate and sends back the result to the provider's server. Since the password continually changes and used only once, it will tremendously reduce the possibility of cracking the password. Therefore, the personal privacy is securely protected.

The authentication method introduces two technologies: electronic card 1 (integrated with a complete microcomputer system and a magnetic simulator) and a symmetric encryption algorithm being run by both the card and the authentication server. The card consists of a micro controller unit 10, a multi-digit wakeup membrane keypad 5, one magnetic strip simulator 20 (simulating Track I and Track II typically), an ultra-thin coil cell or battery 14, two micro switches 80, and an ultra thin liquid crystal display panel 15 as in FIG. 3. All these parts are implanted into a conventional plastic card to keep the same dimension as the traditional plastic credit card. The micro controller unit 10 includes a central processing unit (CPU), a random access memory (RAM), a clock timer, a read only memory (ROM), and some peripherals. The micro controller unit 10 can be in a standby mode for power saving when not in service, during which time no data is displayed on the liquid crystal display panel 15. Pressing a concave keypad called “wakeup” will wake up the micro controller unit 10 from the standby mode. The system employs a PIN in the form of a combination of digits, or alternatively fingerprint recognition technology, to prevent the card from unauthorized activation. This means that only after the PIN or the fingerprint is verified by the micro controller unit 10, will it be ready to transfer the card information to the magnetic strip simulators 20 and generate the instant certificate code which is then displayed on the liquid crystal display panel 15. Only one of the two micro-switches 80 mounted beside the simulators 20 needs to be pressed. The simulator 20 emulates the magnetic strip data Track I, Track II, or Track III in ISO7811 format. The simulator 20 is a multi-turn conductive winding 60 that is particularly designed to emulate the magnetic flux generated by a regular magnetic strip as it passes through the read head on a read device. In Addition to the transmission of the traditional credit card data to the read device, the simulator 20 also attaches a digital certificate code to the data. This digital certificate code is instantly generated by a cryptographic algorithm at the moment a transaction is in process. The account number is to be input into the card using a special input device by the card issuer prior to shipping the card to a cardholder, but the algorithm is stored in the card in on-chip read only memory (ROM). The certificate code is a function of the account number, expiration date, card issuing date and time, and transaction date and time. The micro controller unit 10 employs a built-in clock timer to form a calendar and a clock by micro-code, a low-level assembly language used for programming micro controller 10. The date and the time used in the algorithm are in GMT at the card and the authentication server 220. The two micro-switches 80 in FIG. 5 are used to trigger the micro controller unit 10 to fetch the date and the time as input variables to the algorithm at the instant transaction moment, and to start the magnetic flux emulation of the transaction data on the simulator 20. The first switch 80 is used for activation of swiping from one side, and the second switch 80 for swiping from the other side. Upon receiving the data and the certificate code, the authentication server executes the same algorithm in terms of the received transaction data and the prompt transaction date and time to create a confirmation code. Then, the authentication server 220 compares it to the certificate code received from the card for finalizing the verification. In order to prevent a shift of the verification code into minutes earlier or later due to time deviation between the server 220 and the micro controller unit 10, some error tolerance should be encompassed. A self-adoptive and an error compensation method are employed to achieve this. With this method, each time a transaction is being processed, the server 220 checks the time difference between the card and the server 220. If the difference exists for a specific card, the server 220 will mark the difference or called error and compensate the error during the next time transaction.

The electronic card 1 is compatible with all credit card transaction instruments either online or offline, even emerging technologies like PDA and cell phone transactions. Multiple of conventional credit card data are implanted into one electronic card 1 for cardholder's convenience. For a transaction using a regular credit card read device at the Point of Sale (POS), the cardholder must type in the PIN from the keypads on the card surface (or for the high-end electronic card 1, the fingerprint recognition replaces the PIN) and hand the card to a cashier as usual. No handwritten signature is required for the purchase. For a transaction on the Internet, the cardholder types the certificate code, which is instantly displayed on the liquid crystal display panel 15 from the keyboard on a PC or keypad on any electronic device prior to clicking the “SEND” icon on the screen. For all other offline transactions, the merchants simply need to write down the account number, the digital certificate, and the transaction date and time, for follow-up authentication by the authentication server 220. With this invention, electronic card 1 cardholders and merchants will no longer have to worry about the credit card data being revealed. The present method and apparatus can be easily migrated to all other verification of the electronic card 1 cardholder identity. Modern electronics and micro-assembly technologies will allow this card to have similar dimensions (length, width, and thickness) as standard credit cards with little or no need to modify current read devices and the transaction data transit network system. The micro controller unit 10 will notify the cardholder to change the battery 14 in the coin cell when it is nearly empty. Changing the battery 14 will not lead to loss of the credit card data in the random access memory (RAM), nor will it stop the clock timer because a capacitor whose capacity is large enough to keep the micro controller unit 10 running in a standby mode operates while changing the battery 14. The cost of the card would be approximately a few dollars, therefore the implementation of this invention will be readily accepted by customers and merchants. By replacing all conventional credit cards worldwide, the electronic card 1 cardholders and the card issuing institutions will be able to save billions of dollars each year due to loss from credit card fraud and the invention will significantly facilitate B2C e-commerce.

I claim:

1. An electronic card being made of a substantially rigid material, having a substantially flat surface and a dimension substantially similar to that of a conventional credit card, the electronic card being capable of securing an authorized financial transaction and a personal online account access by a user, comprising:
a. a micro controller unit for verifying a pre-assigned user input information, the micro controller unit comprising:
i. a central processor unit,
ii. a memory being capable of storing the pre-assigned user input information, and
iii. a clock timer to generate a date and time by a micro-code;
b. a membrane keypad having a plurality of digits, the membrane keypad being mounted on the surface of the electronic card, for entering the pre-assigned user input information;
c. a magnetic strip simulator designed to:
i. emulate a magnetic flux to be generated while the electronic card passes through a read head on a read device;
ii. emulate a traditional credit card transaction data;
iii. generate a dynamic digital certificate code to the transaction data;
iv. transmit the transaction data to the read device; and
d. a battery embedded within the electronic card; and
e. a liquid crystal display panel located on the flat surface for displaying the certificate code.

2. The electronic card of claim 1, wherein the magnetic strip simulator further comprises a conductive winding to simulate a track.

3. The electronic card of claim 2, wherein the track is Track I magnetic strip in ISO7811 format.

4. The electronic card of claim 2, wherein the track is Track II magnetic strip in ISO7811 format.

5. The electronic card of claim 2, wherein the track is Track III magnetic strip in ISO7811 format.

6. The electronic card of claim 1 further comprising a cryptographic algorithm stored in the memory for generating the dynamic digital certificate code prior to transmitting the transaction data.

7. The electronic card of claim 6, wherein the dynamic digital certificate code is calculated based on the cryptographic algorithm containing the following variables:
a. a credit card account number of the user,
b. an expiration date of the user's credit card,
c. a card issuing date in Greenwich Mean Time (GMT),
d. a card issuing time in GMT,
e. an instant transaction date in GMT, and
f. an instant transaction time in GMT.

8. The electronic card of claim 1 further comprising two micro switches for triggering the micro controller unit to obtain a transaction date and a transaction time as input variables to the cryptographic algorithm at an instant transaction moment, and for starting the magnetic flux emulation of the transaction data on the simulator.

9. The electronic card of claim 1, wherein the membrane keypad has ten digits.

10. The electronic card of claim 1, wherein the pre-assigned user input information is a personal identification number consisting of a plurality of numerals.

11. The electronic card of claim 1, further comprising an integrated fingerprint sensor on the surface of the electronic card for authenticating the user,
wherein the pre-stored user's fingerprint template is verified by the micro controller unit through implementation of a digital signal processing of a fingerprint data of the user, the fingerprint data being obtained by the integrated fingerprint sensor when the user presses one of his fingers on the integrated fingerprint sensor.

12. The electronic card of claim 1, which is capable of functioning as a major brand credit card.

13. A method of conducting a secured transaction using an electronic card, said method comprising the steps of:
a. providing the electronic card having a micro controller unit being capable of storing a pre-assigned user input information and producing a dynamic digital certificate code;
b. inputting by a user of the pre-assigned user input information for verification by the micro controller unit;
c. verifying by the micro controller unit of the pre-assigned user input information;
d. producing of the dynamic digital certificate code by the micro controller unit only when the pre-assigned user input information agrees with the pre-assigned user input information stored in the micro controller unit;
e. providing a transaction processor being capable of transmitting and receiving back a transaction request;
f. providing an authentication server being capable of receiving and transmitting the transaction request, the authentication server being capable of producing a dynamic confirmation code and comparing the dynamic digital certificate code and the dynamic confirmation code;
g. producing by the authentication server of the dynamic confirmation code upon receiving the transaction request from the transaction server;
h. comparing by the authentication server of the dynamic digital certificate code and the dynamic confirmation code; and
i. transmitting by the authentication server of the transaction request back to the transaction processor only when the dynamic digital certificate code agrees with the dynamic confirmation code.

14. The method of claim 13, wherein the electronic card in the providing step is made of a substantially rigid material, has a substantially flat surface, and has a dimension substantially similar to that of a conventional credit card, the electronic card further comprises:
a. a user input information receiving device on the surface of the electronic card;
b. a magnetic strip simulator designed to:
i. emulate a magnetic flux to be generated while the electronic card passes through a read head on a read device;
ii. emulate a traditional credit card transaction data;
iii. generate a dynamic digital certificate code to the transaction data; and
iv. transmit the transaction data to a read device; and
c. a battery embedded within the electronic card; and
d. a liquid crystal display panel located on the surface of the electronic card for displaying the dynamic digital certificate code, and
e. wherein the micro controller unit further comprises:
i. a central processor unit,
ii. a memory, and
iii. a clock timer to generate a date and time by a micro-code.

15. The method of claim 14, wherein the user input information receiving device is a membrane keypad having a plurality of digits, wherein the pre-assigned user input information is a personal identification number consisting of a plurality of numerals.

16. The method of claim 14, wherein the user input information receiving device is an integrated fingerprint sensor on the surface of the electronic card for authenticating the user,
wherein the pre-stored user's fingerprint template is verified by the micro controller unit through implementation of a digital signal processing of a fingerprint data of the user, the fingerprint data being obtained by the integrated fingerprint sensor when the user presses one of his fingers on the integrated fingerprint sensor.

17. The method of claim 13, wherein the dynamic digital certificate code is calculated based on the cryptographic algorithm containing the following variables:
a. a credit card account number of the user,
b. an expiration date of the user's credit card,
c. a card issuing date in Greenwich Mean Time (GMT),
d. a card issuing time in GMT,
e. an instant transaction date in GMT, and
f. an instant transaction time in GMT.

18. The method of claim 13, wherein the dynamic confirmation code is calculated based on the cryptographic algorithm containing the following variables:
a. a credit card account number of the user,
b. an expiration date of the user's credit card,
c. a card issuing date in Greenwich Mean Time (GMT),
d. a card issuing time in GMT,
e. an instant transaction date in GMT, and
f. an instant transaction time in GMT.

19. The method of claim 13, wherein the electronic card in the providing step a. further performing a symmetric encryption algorithm, and wherein the authentication server in the providing step b. further performing another symmetric encryption algorithm.

20. The method of claim 13, wherein the transmitting step further comprises an error compensation, whereby each time a transaction is being processed by the method, the authentication server checks a difference between a transaction time transmitted by the micro controller unit and another transaction time measured by the transaction server, and the transaction request is transmitted to the transaction processor when the difference in two transaction times deviate within the preset tolerance, and when the difference exists, the server records the difference and deducts such difference at the next authentication processing from the transaction time transmitted by the micro controller unit.

21. The method of claim 14 further comprising a step of displaying a transaction data necessary to perform the secured transaction on the liquid crystal display panel.
